(19) United States
(12) Patent Application Publication
(10) Pub. No.: US 2018/0216339 A1
(43) Pub. Date: Aug. 2, 2018

(54) PANEL CORNER JOINERY FOR COLLAPSIBLE AND DURABLE STRUCTURES

(71) Applicant: Karl Alan Schloesser, Colorado Springs, CO (US)

(72) Inventor: Karl Alan Schloesser, Colorado Springs, CO (US)

(21) Appl. No.: 15/418,757

(22) Filed: Jan. 29, 2017

(51) Int. Cl. E04B 1/61; F16B 5/06

(52) U.S. Cl. CPC E04B 1/6112; E04B 2001/6195; F16B 5/0614

(57) ABSTRACT

A Secure and durable method of constructing a permanent or re-usable corner joint from adjoining side or wall panels forming a rigid side or wall corner joint assembly. These panel corner assemblies can be incorporated into the construction of temporary or permanent structures like boxes, crates, containers, displays, sheds, playhouses, greenhouses, and buildings.

### CROSS-REFERENCE TO RELATED APPLICATIONS

This patent claims the benefit of Provisional Patent Application U.S. 62/292,828 filed Feb. 8, 2016.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### SEQUENCE LISTING

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

Attempts to produce a durable, secure, and re-usable panel corner construction by joining two or more panels together forming a corner for the sides or walls of a box, container, or building have not sufficiently addressed the needs of industry owning to its awkwardness, security concerns, and re-usability shortfalls. Needed is a simple panel corner construction method utilizing securing construction elements e.g. clamps, clips, or brackets with jointing elements to produce walled or panel corner construction. Various panel corner constructions have hereto-fore been provided, however have short comings due to the complexity, awkwardness, time consuming to construct, durability failings, are not reusable, or have high cost to produce. U.S. Pat. No. 4,192,113 in the name of Martin, Jr. produces a panel corner, but is complicated and expensive to produce and may be difficult to erect. U.S. Pat. No. 4,120,130 in the name of Puschkarski utilizes clamping jaws and cylindrical bodies to produce a corner joint applicable to be “used for constructing a stall at a fair or a display stand”, but fails to provide durability needed for more lasting structures. U.S. Pat. No. 5,404,684 in the name of Schwendeman relates to panels made of thin material such as metal sheets and would fail to produce adequate joinery beyond very thin panels like sheet metal.

This invention produces a rigid, ease of use, low cost, durable panel corner joint that can be used for re-usable or permanent construction of structures made using wall panels to produce containers, boxes, crates, displays, sheds, playhouses, greenhouses, or buildings.

### (1) FIELD THE INVENTION

(CPC) E04B 1/61, E04B 1/343, E04B 9/008, E04B 9/28, E04B 2001/1963, E04B 2001/199, E04B 2001/2415, E04B 2001/2424, E04B 2001/2481, E04B 2001/2636, E04B 2001/6191, E04B 2001/6195, E04B 1/34321, E04B 1/6112, E04B 1/6158, E04B 2002/725, E04B 2002/7462, E04H 1/12, F16B 42F 3/00, F16B 12/02, F16B 12/18, F16B 12/50, F16B 1/02.

(USPC) 052/79.5, 052/127.6, 052/270, 052/282.5, 052/741.12, 052/741.13, 052/742.15, 053/457, 053/458, 108/159.11

### (2) REFERENCES AND RELATED ART CITED

Martin, Jr. U.S. Pat. No. 4,192,113 Mar. 11, 1980, Puschkarski U.S. Pat. No. 4,120,130 Oct. 17, 1978. Cohen D286,743 Nov. 18, 1986, Adderton U.S. Pat. No. 6,546,675 Apr. 15, 2003, Schwendeman U.S. Pat. No. 5,404,684 Apr. 11, 1995, Nelsson U.S. Pat. No. 3,962,840 Jun. 15, 1976, Litchfield U.S. Pat. No. 4,002,261 Jan. 11, 1977, Menchetti U.S. Pat. No. 5,575,131 Nov. 19, 1996, Webb U.S. Pat. No. 4,673,087 Jun. 16, 1987, Bottin U.S. Pat. No. 9,493,945 Nov. 15, 2016, Chong U.S. Pat. No. 9,228,337 Jan. 5, 2016, Dziewolski U.S. Pat. No. 4,187,034 Feb. 5, 1980, Prica et al. U.S. Pat. No. 9,359,772 Jun. 7, 2016, Schulte U.S. Pat. No. 5,070,667 Dec. 10, 1991, Hugens U.S. Pat. No. 4,258,519 Mar. 31, 1981, Mower et al. U.S. Pat. No. 7,707,783 May 4, 2010, Mower et. al. U.S. Pat. No. 7,926,227 Apr. 19, 2011, Bullard III et al. U.S. Pat. No. 6,446,414 Sep. 10, 2002, Mandell D421,133 Feb. 22, 2000, Carroll et al. U.S. Pat. No. 6,964,138 Nov. 15, 2005, Glick et al. U.S. Pat. No. 8,015,767 Sep. 13, 2011, Walton U.S. Pat. No. 3,975,877 Aug. 24, 1976, Erickson U.S. Pat. No. 5,398,468 Mar. 21, 1995, Ohanesian D455,219 Apr. 2, 2002, Lijesnic U.S. Pat. No. 8,720,839 May 13, 2014, Ghyczy U.S. Pat. No. 3,966,388 Jun. 29, 1976, Shemitz U.S. Pat. No. 4,343,117 Aug. 10, 1982.

### BRIEF SUMMARY OF THE INVENTION

Disclosed invented method of constructing a corner joint adjoining sides or walls together forming a rigid side or wall corner joint assembly. These side or wall corner joint assemblies can be assembled together constructing multiple sides or wall joint assemblies, thus joining several assemblies together will form side or wall construction that can be used to erect structures like boxes, crates, containers, play houses, sheds, walls or buildings of various size. This invented method can be scaled up or down and used with a range of panel materials including but not limited to plastics, woods, laminations, or metals to structure specifications and strength requirements of the required structure.

### BRIEF DESCRIPTION OF THE SEVERAL VIEWS OF THE DRAWING(S)

FIG. 1 shows an isometric view of a panel corner assembly with two angled edge panels (12A, 12B) with pockets (17), joined with draw-together hardware (14) forming a corner joint.

FIG. 2 shows a close up isometric view of a panel corner assembly with two angled edge corner panels with pockets joined showing a single draw-together hardware, complementing FIG. 1.

FIG. 3 shows an exploded isometric view of components for an angled edge corner panel with pockets joint, complementing FIG. 1.

FIG. 4 shows an isometric view of a panel corner assembly with two interlaced square edge panels joined (22A, 22B), with pockets (17), joined with draw-together hardware (14) forming a corner joint.

FIG. 5 shows a close up isometric view of a panel corner assembly with two interlaced square edge panels with pockets joined showing a single draw-together hardware, complementing FIG. 4.

FIG. 6 shows an exploded isometric view of a panel corner assembly with all components for an interlaced square edge with pockets corner panel joint, complementing FIG. 4.

FIG. 7 shows an isometric view of a panel corner assembly with two panels joined (32A, 32B) using angled edges and a pin type inside compression bracket (33) and hole (37) forming a corner joint.

FIG. 8 shows a close up isometric view of a panel corner assembly with two angled edge panels with holes joined showing a single pin type inside compression bracket, complementing FIG. 7.

FIG. 9 shows an exploded isometric view of a panel corner assembly with components for an angled edge corner joint with pin type inside compression brackets and holes, complementing FIG. 7.

FIG. 10 shows an exploded isometric view of a panel corner assembly with two angled edge panels (42A. 42B) with an external lip (47), joined with draw-together hardware (13, 4A, 4B).

FIG. 11 shows a close up isometric view of a panel corner assembly with two angled edge panels, complementing FIG. 10.

### DETAILED DESCRIPTION OF THE INVENTION

The disclosed invention of corner joinery connects one adjacent panel (12A) to another (12B) with joining hardware for the purpose of constructing a ridged side or wall corner. The disclosed method allows for adjacent panels to form the corners of sides, walls, bottom, or structure top to be temporarily or permanently assembled. Fastening panels together will form a wall or side and corner sections used for the erection of permanent or re-useable containers, boxes, crates, erected structures, play houses, sheds, sides, walls, or buildings.

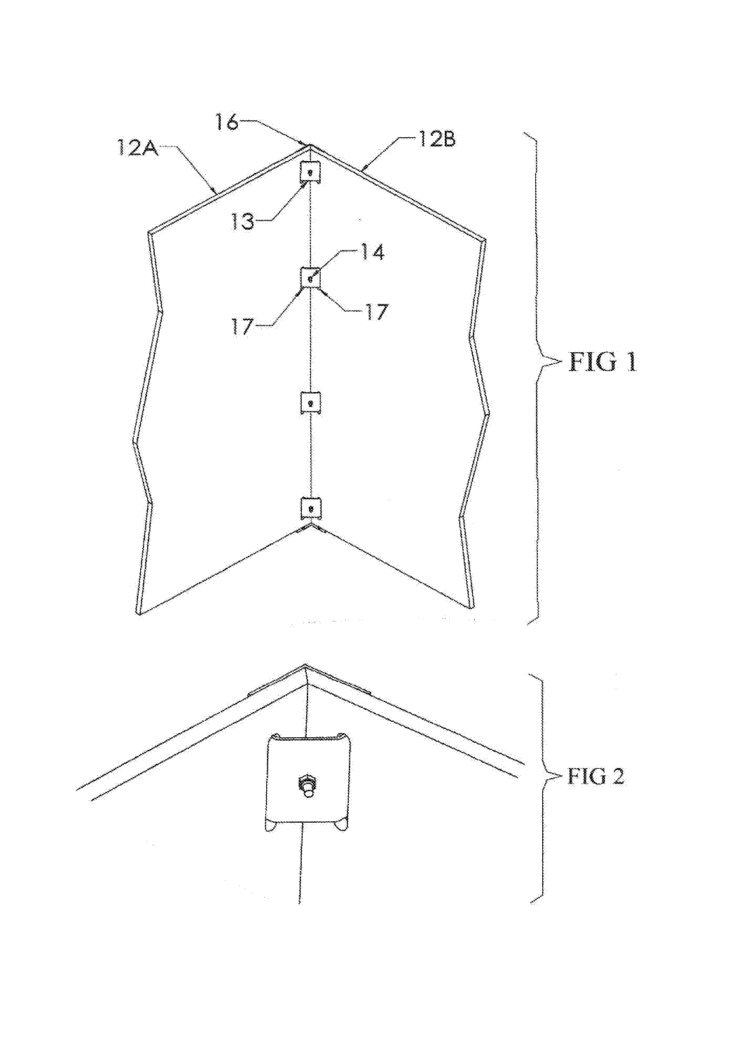

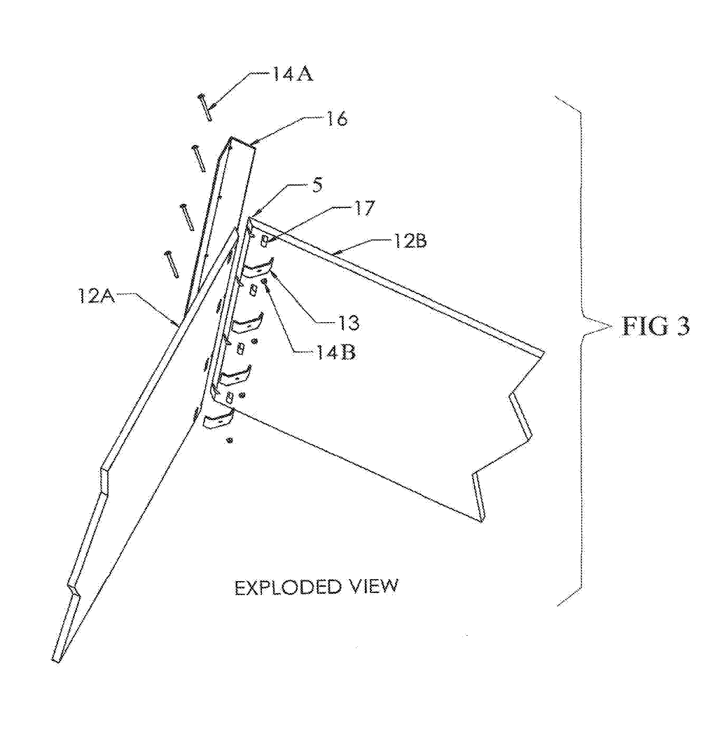

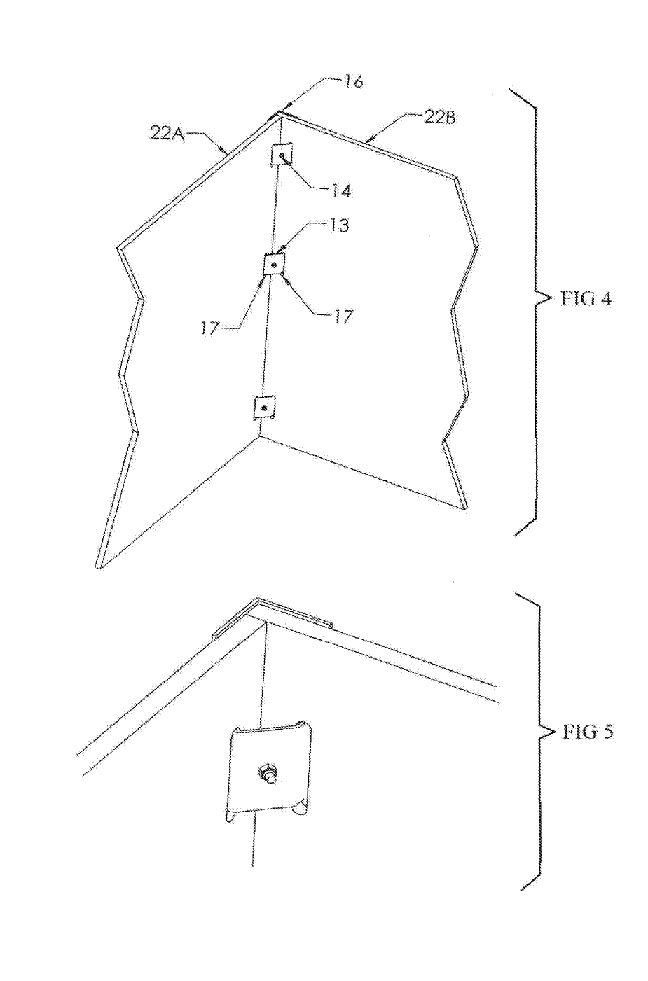

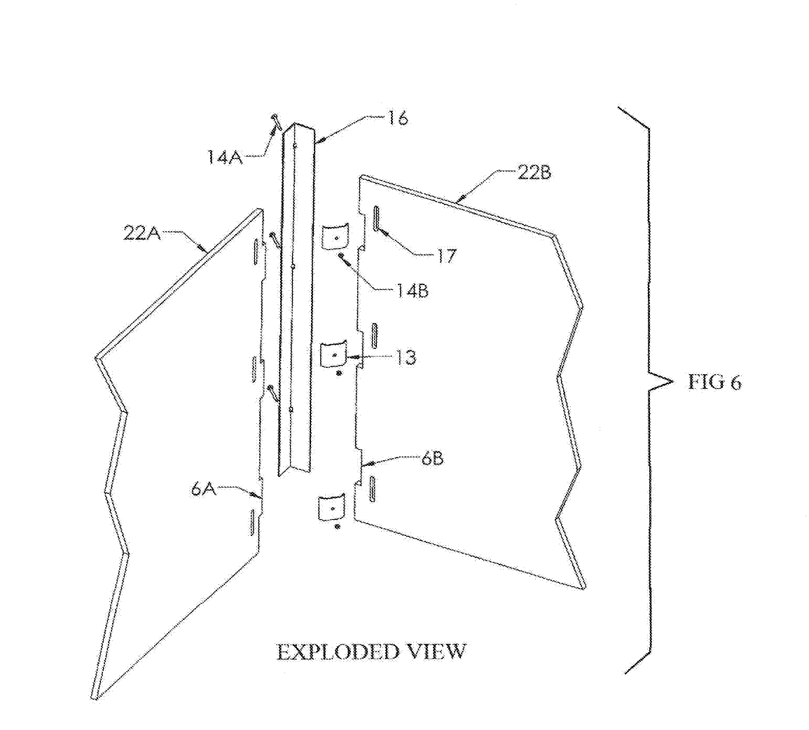

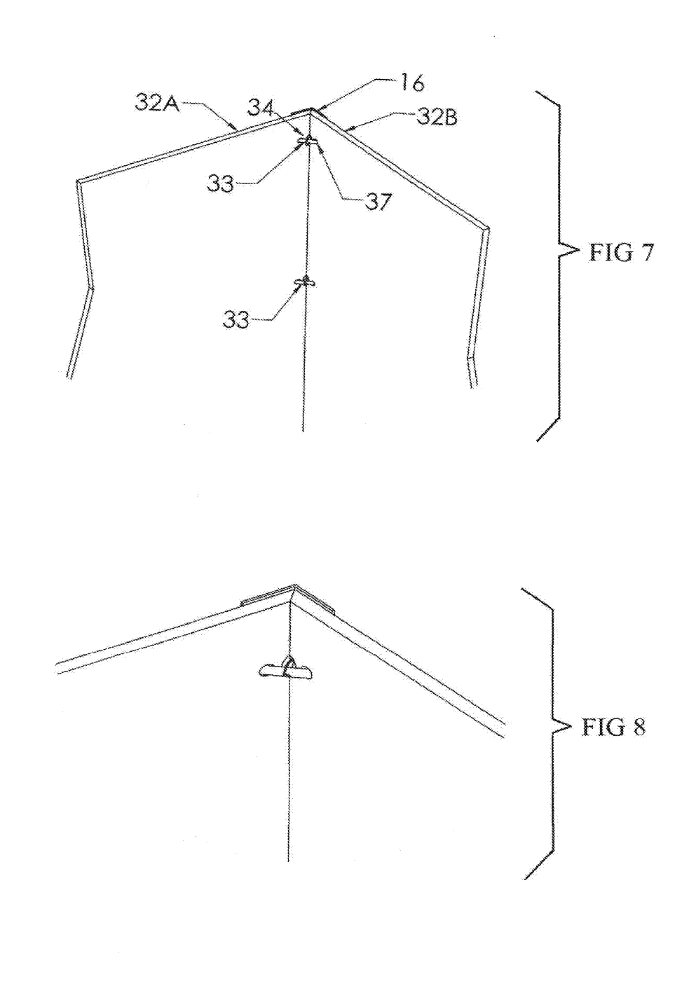

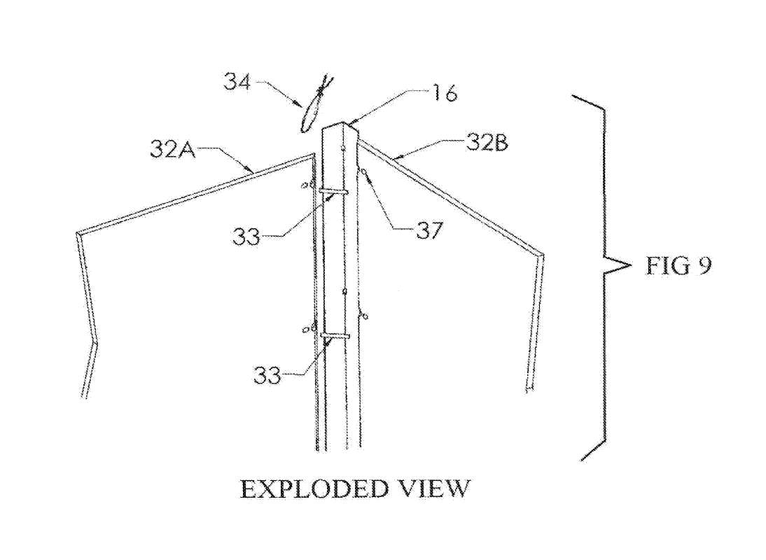

FIG. 3 shows the angled panel edge (5) corner joint in an exploded view. Close up joint detail is shown in FIG. 2 displaying the panel joint employing an angled panel edge configuration. FIG. 1 shows an example of typical construction of the corner joint with the angled panel edge (5) once assembled. The flat type inside compression bracket (13) can be of various geometry but will serve the same function and utility. FIG. 4, FIG. 5, and FIG. 6 display an example of the corner joint with interlaced panel edge (6A) and (6B) configuration. FIG. 7, FIG. 8, and FIG. 9 display an example of the corner joint with the pin (round, square or angle) type inside compression bracket (33) configuration. All panel joint configurations can be mixed and matched to produce the same corner joint utility and function.

The disclosed method can be scaled up or down using panel and joining materials including but not limited to plastics, woods, metals, or laminations designed to structure specifications and strength requirements of the required structure. As displayed in FIG. 1, FIG. 4, and FIG. 7, the number and size of the inside compression brackets (13) and (33), draw-together hardware or threaded fastener hardware (14) and (34), panel pocket features (17) and (37), and corner bracket(s) (16) may vary depending on design specifications of the required structure, but will have the same utility. Upon assembly or re-assembly, the panel joint is constructed to form a single side or wall corner assembly, FIG I. FIG. 4. FIG. 7. Four side or wall corner assemblies will create a square or rectangle. 8 side or wall corner assemblies will create a box with a bottom, and twelve side or wall corner assemblies will create a box with a bottom and top. As displayed in FIG I and FIG. 3, two adjoining panels (12A), (12B) with angles or features along the joining edges mate with the corresponding outside corner bracket(s) (16), flat type inside compression bracket(s) (13), and draw-together hardware or threaded fastener hardware (14). Upon tightening the draw-together hardware or threaded fastener(s) a side or wall panel corner joint will be produced as the flat type inside compression bracket(s) (13) engage the adjacent panel pocket features (17) driving the panels (12A), (12B) together and securing them together forming a side or wall corner joint by compressing against the corner bracket(s) (16). Panel edge exploded view is shown in FIG. 3 displaying the panel employing an angled panel edge (5). FIG. 2 shows detail of the angled panel edge once assembled. In addition other panel configurations as shown in FIG. 6 with interlocking panel edges (6A) and (6B), with detail of the assembled interlocking panel edge in FIG. 5. FIG. 7 and FIG. 9, display additional utility of this corner joint incorporating round pocket features (37) along the inside corner edges of the adjacent corner panels (32A and 32B) to be mechanically drawn together by a wire, zip tie, or similar fastening device (34). As the panels draw in, the panels are compressed between the outside corner bracket (16) and the pin type inside compression bracket(s) (33). FIG. 8 displays the joint detail of the assembled panels employing the pin type inside compression bracket and the angled panel edges (5).

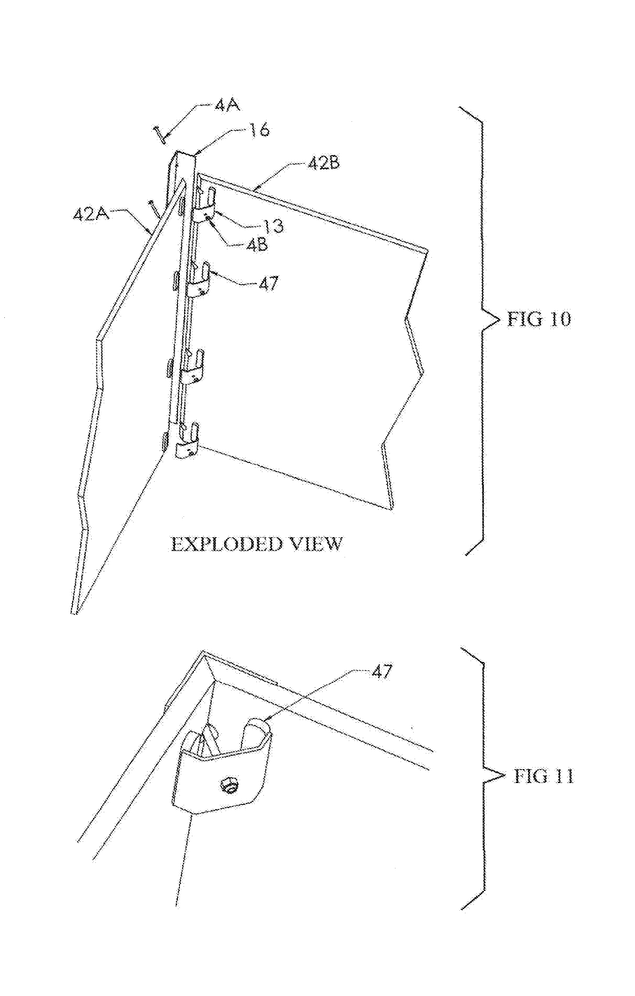

Both the flat type inside compression bracket (13) and the pin type inside compression bracket (33) are drawn into the corner by mechanical force and both drive the adjacent panels together into the corner. While mechanically drawn inwards, the engaging ends of either the flat type inside compression bracket (13) or the pin type inside compression bracket (33) will bottom out against the bottom of the pocket feature or hole, or will engage with the external lip or feature (47). This action creates pressure forcing the adjacent panels outward against the inside edges of the outside corner bracket(s) (16). The joint edges of the adjacent panels both compress against the inside of the outside corner bracket(s) (16) and the adjacent panel joint edge shown in FIG. 2. FIG. 5, and FIG. 8. The combination of these actions produces a very strong corner joint. The draw in, and compression action of this joint method has the same function and utility if employed with external lips, edges, raised profiles, or attached features (47) to the corner edges of the adjacent panels to be joined, FIG. 10, FIG. 11. All panel joining configurations produce the same corner joint utility and function.

This invention allows a panel side or wall corner joint to be produced that can be combined with additional panel corners to produce both permanent or collapsible and re-usable structures that can be assembled and disassembled with multiple re-uses.

1. A method of constructing a corner joint incorporating adjoining members to include sides, walls, planks, slabs, or panels (12A) and (12B), (22A) and (22B), or (32A) and (32B) with pocket(s) or feature(s) along the joint side of the wall, or side (17) or (37), utilizing compression bracket(s) (13), (33), corner bracket(s) (16), and draw-together hardware (14), (34) to produce a corner joint.
As described in claim 1, the adjoining members can have different corner edge preparation to include angle connecting edges (5) and interlaced (6A), (6B) connecting edges including attached edge features to produce the connecting edge profile to the adjoining member with the same functionality and utility. The corner edge preparation can be of various size and geometry with the same function and utility.
As described in claim 1, each pocket(s) or feature(s) (17) and (37) can be of various size and geometry to include concave or depression including a hole, slot, groove or pocket. Or the feature can be a convex feature, raised profile, lip or attachment to the adjoining member with the same function and utility (47). Any combination of these features may be used together or independently.
As described in claim 1, the geometry, size, material, and the number of the flat type inside compression bracket(s) (13), or the pin type inside compression bracket(s) (33) having the same function and utility, will allow for structure design flexibility as needed. The pin type inside compression bracket(s) (33) geometry may also include square or angled material. Various combinations of inside compression brackets are allowed for mix and match within a single corner joint. Various combinations of materials can be used for the inside compression bracket(s) but are not limited to metals, plastics, woods, or laminations depending on structure requirements.
As described in claim 1, the size, material, and the number of draw-together hardware will allow for user flexibility. Draw-together hardware may include but is not limited to threaded nuts/bolts (14), ties, wire, cable, zip ties, re-usable ties (34), or straps and allow for the same functionality.
As described in claim 1, the corner bracket(s) (16) may be single corner bracket or a plurality of bracket(s) within the same corner joint. The shape, size and material of the corner bracket(s), can be made from but not limited to metals, plastics, woods, and laminations. Additionally the corner bracket(s) (16) can include fixed or welded in draw-together hardware as a single corner bracket assembly or with separate draw-together hardware to be assembled producing the same draw-together function of the corner joint.
As described in claim 1, the corner joinery is not limited to construction of 90 degree angle corner joints.

2. This invention reveals the corner joinery is not limited to joining two adjoining members such as sides, walls, planks, slabs, or panels (12A), (12B) or (22A), (22B) or (32A), (32B), or (42A), (42B), but may join multiple sets of corners within a structure. As described in claim 2, a plurality of corner edge types including angled edge corner joinery (5) and interlaced corner edge corner joinery (6A), (6B) can be employed within a single structure.
